(19) United States
(12) Patent Application Publication
(10) Pub. No.: US 2025/0180836 A1
(43) Pub. Date: Jun. 5, 2025

(54) PACKAGING STRUCTURE AND MANUFACTURING METHOD THEREOF, AND PHOTONIC INTEGRATED CIRCUIT CHIP

(71) Applicant: Shanghai Xizhi Technology Co., Ltd., Shanghai (CN)

(72) Inventors: Dadi SETIADI, Shanghai (CN); Jianhua WU, Shenzhen, Guangdong (CN); Zhan SU, Shanghai (CN); Zhiquan XUE, Shanghai (CN); Robert PATTI, Shanghai (CN)

(73) Assignee: Shanghai Xizhi Technology Co., Ltd., Shanghai (CN)

(21) Appl. No.: 18/842,042

(22) PCT Filed: Feb. 26, 2023
(86) PCT No.: PCT/CN2023/078309

§ 371 Date: Aug. 28, 2024

(30) Foreign Application Priority Data
Feb. 28, 2022 (CN) 202210189637.4

(51) Int. Cl. G02B 6/42

(52) U.S. Cl. CPC G02B 6/4248

(57) ABSTRACT

Disclosed are a packaging structure and a manufacturing method thereof, and a photonic integrated circuit chip (800). The manufacturing method of the packaging structure includes: providing a photonic integrated structure (100) including first openings (111) and a conductive material disposed in each first opening (111); providing a first substrate (201) including second openings (202) and a conductive material (204a) disposed in each second opening (202); and bonding the photonic integrated structure (100) and the first substrate (201) such that each first opening (111) is aligned with a corresponding second opening (202) and the conductive material in the first opening (111) is electrically connected with the conductive material (204a) in the corresponding second opening (202).

This application claims priority to Chinese Patent Application No. 202210189637.4, filed with CNIPA on Feb. 28, 2022, and entitled “PACKAGING STRUCTURE AND MANUFACTURING METHOD THEREOF, AND PHOTONIC INTEGRATED CIRCUIT CHIP”. The disclosure of the aforementioned application is incorporated herein by reference in its entirety.

### TECHNICAL FIELD

The present disclosure relates to the field of semiconductors, and more specifically, to a packaging structure and a manufacturing method thereof, and a photonic integrated circuit chip.

### BACKGROUND

In a packaging process of photonic integrated circuits, it is sometimes desired, for a purpose of electrical connection, to form a conductive structure passing through one or more material layers and penetrating a substrate in a photonic integrated circuit.

There are still some challenges in forming vias in a growth substrate of a photonic integrated circuit. For example, the process for forming the vias is possibly not mature, or some device(s) in the photonic circuit may be affected due to the process and other factors.

### Technical Problems

Embodiments of the present application provide a packaging structure and a manufacturing method thereof, and a photonic integrated circuit chip, which may not only address manufacturing difficulties in forming a conductive structure passing through a growth substrate in a photonic integrated circuit, but also optimize an electrical connection between an electrical connection structure in the photonic integrated circuit and an electrical connection structure in a first substrate.

### Technical Solutions

Embodiments of the present application provide a packaging structure, a manufacturing method thereof, and a photonic integrated circuit chip.

In a first aspect, embodiments of the present application provide a method for manufacturing a packaging structure, including: providing a photonic integrated structure including one or more first openings, and a conductive material disposed in each of the one or more first openings; providing a first substrate including one or more second openings, and a conductive material disposed in each of the one or more second openings; and bonding the photonic integrated structure and the first substrate such that each of the first openings is aligned with a corresponding one of the second openings and the conductive material in the first opening is electrically connected with the conductive material in the corresponding second opening.

In some embodiments, the photonic integrated structure includes a first dielectric layer, and the one or more first openings pass through the first dielectric layer.

In some embodiments, the one or more second openings pass through the first substrate.

In some embodiments, the first substrate has a first side and a second side opposite to the first side, and the manufacturing method further includes: thinning the first substrate from the second side of the first substrate, so that the one or more second openings pass through the first substrate.

In some embodiments, the providing of the photonic integrated structure comprises: forming the photonic integrated structure based on a Silicon-On-Insulator (SOI) substrate, wherein the SOI substrate includes a back substrate, an insulating layer, and a top silicon layer, and the first dielectric layer is formed from the insulating layer in the SOI substrate; removing the back substrate; and forming the one or more first openings in the first dielectric layer.

In some embodiments, the one or more first openings are formed in the first dielectric layer after the back substrate is removed.

In some embodiments, the one or more first openings are formed in the first dielectric layer before the back substrate is removed.

In some embodiments, the photonic integrated structure has a first side and a second side opposite to the first side, the first dielectric layer is located on the second side of the photonic integrated structure, and the bonding is performed with the second side of the photonic integrated structure facing toward the first substrate.

In some embodiments, the method further includes: forming a fifth dielectric layer on the first side of the first substrate; forming one or more third openings, wherein the one or more third openings pass through the fifth dielectric layer, and the one or more third openings are each aligned with a corresponding one of the one or more second openings; and forming a conductive material in each of the one or more third openings, wherein when performing the bonding of the photonic integrated structure and the first substrate, the fifth dielectric layer is located between the photonic integrated structure and the first substrate, and the conductive material in each of the one or more third openings is electrically connected to the conductive material in the corresponding one of the one or more second openings.

In some embodiments, the method further includes providing a redistribution layer on a side of the first substrate away from the photonic integrated structure.

In some embodiments, the method further includes, after the bonding of the photonic integrated structure and the first substrate, providing a redistribution layer on the second side of the first substrate.

In some embodiments, the first dielectric layer has a first side and a second side opposite to the first side, the photonic integrated structure includes one or more photonic devices disposed on the first side of the first dielectric layer, and the second side of the first dielectric layer is bonded to the first substrate.

In some embodiments, the one or more photonic devices include at least one of a waveguide, a grating coupler, an optical modulator, a directional coupler, a multi-mode interferometer, a photodetector, and an optical beam splitter.

In some embodiments, a second dielectric layer is formed on the first side of the first dielectric layer, the second dielectric layer covers the one or more photonic devices, and the one or more first openings pass through the second dielectric layer.

In some embodiments, the bonding of the photonic integrated structure and the first substrate is preformed opening an oxide-oxide bonding.

In some embodiments, a plurality of the first openings are aligned with a corresponding one of the one or more second openings.

In a second aspect, embodiments of the present disclosure provide a packaging structure. The packaging structure includes: a photonic integrated structure including one or more first openings, and a conductive material disposed in each of the one or more first openings; a first substrate including one or more second openings, and a conductive material disposed in each of the one or more second openings. Each of the first openings is aligned with a corresponding one of the second openings, and the conductive material in the first opening is electrically connected with the conductive material in the corresponding second opening.

In some embodiments, the photonic integrated structure includes a first dielectric layer, and the one or more first openings pass through the first dielectric layer.

In some embodiments, the photonic integrated structure has a first side and a second side opposite to the first side, the first dielectric layer is located on the second side of the photonic integrated structure, and the second side of the photonic integrated structure faces toward the first substrate.

In some embodiments, the one or more second openings pass through the first substrate.

In some embodiments, the first dielectric layer is formed from an insulating layer in a Silicon-On-Insulator (SOI) substrate, and a back substrate in the SOI substrate is removed.

In some embodiments, the packaging structure includes a fifth dielectric layer located between the photonic integrated structure and the first substrate. The fifth dielectric layer includes one or more third openings and a conductive material disposed in each of the one or more third openings. The one or more third openings pass through the fifth dielectric layer, and each of the one or more third openings is aligned with a corresponding one of the second openings, so that the conductive material in the third opening is electrically connected to the conductive material in the corresponding second opening.

In some embodiments, the first dielectric layer has a first side and a second side opposite to the first side, the photonic integrated structure includes one or more photonic devices disposed on the first side of the first dielectric layer, and the second side of the first dielectric layer is bonded to the first substrate.

In some embodiments, the one or more photonic devices include at least one of a waveguide, a grating coupler, an optical modulator, a directional coupler, a multi-mode interferometer, a photodetector, and an optical beam splitter.

In some embodiments, a second dielectric layer is formed on the first side of the first dielectric layer, the second dielectric layer covers the one or more photonic devices, and the one or more first openings pass through the second dielectric layer.

In some embodiments, the photonic integrated structure is bonded to the first substrate opening an oxide-oxide bonding.

In some embodiments, a plurality of the first openings are aligned with a corresponding one of the one or more second openings.

In some embodiments, the packaging structure has a first surface and a second surface opposite to the first surface, and includes one or more conductive paths extending between the first surface and the second surface of the packaging structure. The one or more first openings provided with conductive material are one or more first conductive openings, and the one or more second openings provided with conductive material are one or more second conductive openings. The one or more conductive paths each pass through one or more of the one or more first conductive openings and one or more of the one or more second conductive openings in sequence along a direction along which the conductive path extends from the first surface to the second surface.

In an exemplary embodiment, a photonic integrated circuit chip is provided. The photonic integrated circuit chip includes: a photonic integrated structure including one or more first openings and a conductive material disposed in each of the one or more first openings; a first substrate including one or more second openings, and a conductive material disposed in each of the one or more second openings. Each of the first openings is aligned with a corresponding one of the second openings, and the conductive material in the first opening is electrically connected with the conductive material in the corresponding second opening.

In some embodiments, the photonic integrated structure includes a first dielectric layer, and the one or more first openings extend in the first dielectric layer, wherein the one or more first openings pass through the first dielectric layer.

In some embodiments, the photonic integrated structure has a first side and a second side opposite to the first side, the first dielectric layer is located on the second side of the photonic integrated structure, and the second side of the photonic integrated structure is bonded towards the first substrate.

In some embodiments, the one or more second openings pass through the first substrate.

In some embodiments, the first dielectric layer is formed from an insulating layer in a Silicon-On-Insulator (SOI) substrate, and a back substrate in the SOI substrate is removed.

In some embodiments, the photonic integrated circuit chip includes a fifth dielectric layer located between the photonic integrated structure and the first substrate, the fifth dielectric layer includes one or more third openings and a conductive material disposed in each of the one or more third openings, the one or more third openings pass through the fifth dielectric layer, and each of the one or more third openings is aligned with a corresponding one of the second openings, so that the conductive material in the third opening is electrically connected to the conductive material in the corresponding second opening.

In some embodiments, the first dielectric layer has a first side and a second side opposite to the first side, the photonic integrated structure includes one or more photonic devices disposed on the first side of the first dielectric layer, and the second side of the first dielectric layer is bonded to the first substrate.

In some embodiments, the one or more photonic devices includes at least one of a waveguide, a grating coupler, an optical modulator, a directional coupler, a multi-mode interferometer, a photodetector, and an optical beam splitter.

In some embodiments, a second dielectric layer is formed on the first side of the first dielectric layer, the second dielectric layer covers the one or more photonic devices, and the one or more first openings pass through the second dielectric layer.

In some embodiments, the photonic integrated structure is bonded to the first substrate opening an oxide-oxide bonding.

In some embodiments, a plurality of the first openings are aligned with a corresponding one of the one or more second openings.

In some embodiments, the photonic integrated circuit chip has a first surface and a second surface opposite to the first surface, and includes one or more conductive paths extending between the first surface and the second surface of the photonic integrated circuit chip. The one or more first openings provided with conductive material are one or more first conductive openings, and the one or more second openings provided with conductive material are one or more second conductive openings. The one or more conductive paths each pass through one or more of the one or more first conductive openings and one or more of the one or more second conductive openings in sequence along a direction along which the conductive path extends from the first surface to the second surface.

### Beneficial Effects

In the packaging structure and the manufacturing method thereof, and the photonic integrated circuit chip of the embodiments of the present disclosure, the photonic integrated structure and the first substrate may be independently manufactured or prepared, without affecting each other, which may shorten an entire production cycle and allow respective appropriate processes to be chosen for manufacturing the photonic integrated structure and the first substrate. In addition, the photonic integrated circuit structure will not be affected during the formation of the opening(s) in the first substrate. Furthermore, the opening(s) in a first dielectric layer in the photonic integrated circuit and the opening(s) in the first substrate may be manufactured by different processes and may have different sizes. In some operations, an original dielectric layer (e.g., the first dielectric layer) in the photonic integrated structure is used for bonding, and no additional bonding structure is required on the photonic integrated structure, reducing a process flow. In addition, the photonic integrated circuit obtained by using the bonding process and the one or more conductive vias passing through the substrate, may be suitable for packaging in more scenarios.

Various aspects, features, advantages, etc., of the embodiments of the present disclosure will be described in detail below with reference to the accompanying drawings. The above aspects, features, advantages, etc., of the present disclosure will become clearer from the following detailed description in conjunction with the accompanying drawings.

Refer to the following description and to the accompanying drawings, specific embodiments of the present disclosure are disclosed in detail and the manner in which the principles of the present disclosure may be employed is illustrated. It should be understood that embodiments of the present disclosure are not thereby limited in scope. Embodiments of the present disclosure include numerous changes, modifications, and equivalents, within the spirit and scope of the appended claims.

Features described and/or illustrated with respect to one embodiment may be used in the same or similar manner in one or more other embodiments, combined with features in the other embodiments, or in place of features in the other embodiments.

It should be emphasized that the term “comprising” when used herein refers to the presence of features, integers, steps, or components, but does not exclude the presence or addition of one or more other features, integers, steps, or components.

### BRIEF DESCRIPTION OF THE DRAWINGS

In order to more clearly illustrate the technical solutions in the embodiments of the present disclosure, the drawings needed to be used in the description of the embodiments will be briefly introduced below. Apparently, the drawings in the following description are only some embodiments of the present disclosure. For those skilled in the art, other drawings can also be obtained based on these drawings without exerting creative efforts.

FIGS. 1A-5B show schematic diagrams of intermediate operations of an exemplary manufacturing method of a packaging structure or related structures.

FIG. 6 shows a schematic diagram of an exemplary packaging structure.

FIGS. 7A-7C show schematic diagrams of intermediate operations of an exemplary manufacturing method of a packaging structure or related structures.

FIG. 8 shows a schematic diagram of an exemplary photonic integrated circuit chip.

### EMBODIMENTS OF THE INVENTION

In a packaging process of photonic integrated circuits, it is sometimes desired, for a purpose of electrical connection, to form a conductive structure passing through one or more material layers and penetrating a substrate in a photonic integrated circuit.

There are still some challenges in forming vias in a growth substrate of a photonic integrated circuit. For example, the process for forming the vias is possibly not mature, or some device(s) in the photonic circuit may be affected due to the process and other factors.

In order to facilitate understanding of various aspects, features, and advantages of technical solutions of the present disclosure, the present disclosure is described in detail below with reference to the accompanying drawings. It should be understood that the embodiments described below are only for illustration and are not intended to limit the scope of the present disclosure.

The terms used herein are for describing particular embodiments only and are not intended to limit the present disclosure. As used herein, the singular forms “a,” “an,” and “the” are intended to include the plural forms as well, unless the context clearly indicates otherwise. It will be further understood that the terms “comprising” and/or “including” when used in this specification specify the presence of stated features, integers, steps, operations, elements, and/or components, but do not exclude the presence or addition of one or more other features, integers, steps, operations, elements, components, and/or groups thereof. As used herein, the term “and/or” includes any and all combinations of one or more of associated listed items, and the phrase “at least one of A and B” means only A, only B, or both A and B. As used herein, a substrate may refer to an uncut substrate, such as an uncut wafer, or a cut substrate. As used herein, a chip may include a die.

Embodiment 1: the embodiment of the present disclosure provides a manufacturing method of a packaging structure and a packaging structure. The manufacturing method of the packaging structure includes providing a photonic integrated structure, wherein the photonic integrated structure includes one or more first openings and a conductive material disposed in the one or more first openings; providing a first substrate, wherein the first substrate includes one or more second openings and a conductive material disposed in the one or more second openings; and bonding the photonic integrated structure and the first substrate to electrically connect the conductive material in each of the one or more first openings with the conductive material in the corresponding one of the one or more second openings.

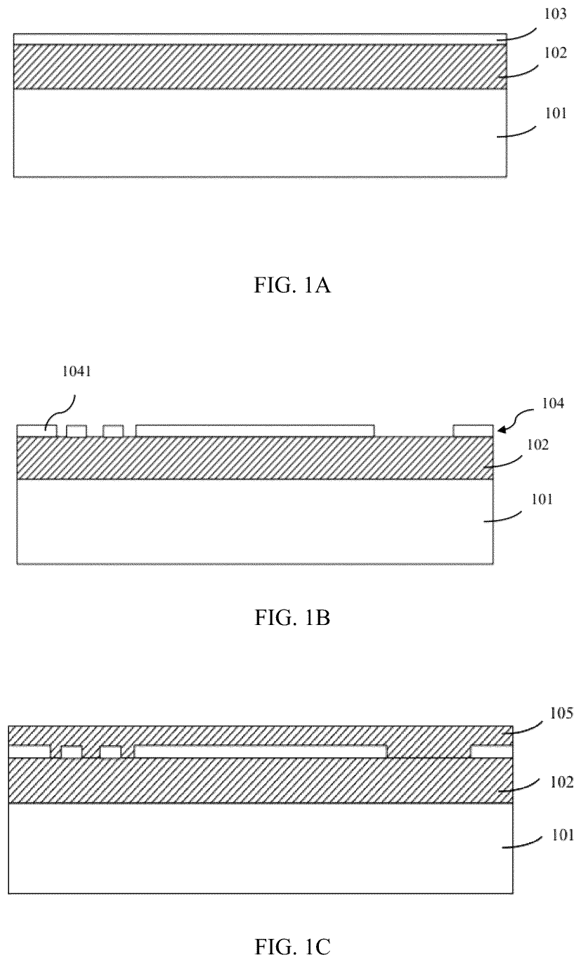

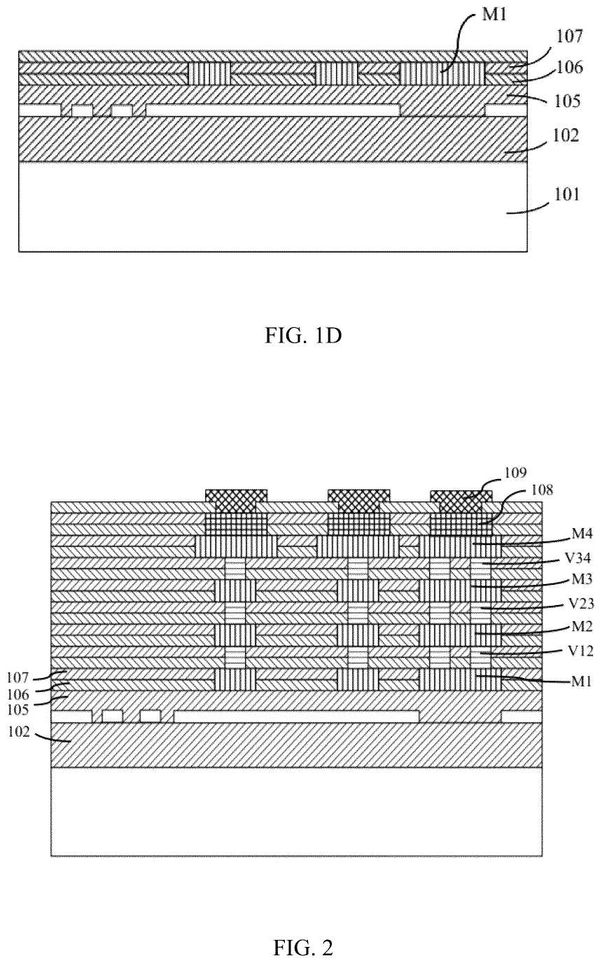

In some embodiments, the manufacturing method of the packaging structure adopts a conventional semiconductor process, and thus is also a manufacturing method of a semiconductor structure, through which the semiconductor structure is obtained. FIGS. 1A to 1C illustrate the forming operations of the provided photonic integrated structure, i.e., operations for manufacturing the photonic integrated structure, wherein the photonic integrated structure includes: the one or more first openings, and the conductive material disposed in the one or more first openings. In some exemplary embodiments, the photonic integrated structure includes a first dielectric layer, and the one or more first openings extend in the first dielectric layer.

As shown in FIG. 1A, specifically, the photonic integrated structure may be manufactured based on a semiconductor layer on an insulator, such as Silicon-On-Insulator (SOI), stacked SiGe-on-insulator (S-SiGeOI), etc. In addition, other substrates may also be provided for manufacturing the photonic integrated structure. The substrate material may be silicon, germanium, silicon carbide, gallium arsenide, or gallium phosphide, may be a compound semiconductor, an alloy semiconductor, etc., or may be a combination thereof. The substrate may be a wafer, such as an SOI wafer. Taking an SOI substrate as an example, the method may include providing an SOI substrate including a back substrate, an insulating layer, and a top silicon layer. For example, the insulating layer is a buried oxide layer. The insulating layer serves as the first dielectric layer. FIG. 1A shows a back substrate 101, a first dielectric layer 102, and a top silicon layer 103. The back substrate 101 may be a wafer, such as a silicon wafer. The first dielectric layer 102 has a first side and a second side opposite to the first side. The top silicon layer 103 is located on the first side of the first dielectric layer 102 and the back substrate 101 is located on the second side of the first dielectric layer 102.

As shown in FIG. 1B, the operations of forming the photonic integrated structure may include forming a photonic device layer 104 based on the SOI substrate. The photonic device layer 104 includes various types of photonic devices, such as a waveguide, a grating coupler, an optical modulator, a directional coupler, a multi-mode interferometer (MMI), a photodetector, and an optical beam splitter, etc. The photonic devices may be formed by performing operations such as photolithography, etching, patterning, etc., on the top silicon layer, and operations such as depositing and doping. The forming operations of the photonic devices may include depositing different types of semiconductor materials and metallic materials.

For example, the photonic devices are located above the first dielectric layer (on the first side thereof), wherein there may be one or more photonic devices for each type of photonic device.

As shown in FIG. 1C, after the formation of the photonic devices, a second dielectric layer 105 is prepared to cover one or more of the photonic devices. A conductive connection structure (not shown in figure) may be provided in the second dielectric layer 105 to be electrically connected to the one or more photonic devices. Optionally, the second dielectric layer 105 may include multiple sub-layers.

Further electrical connection structure(s) and additional material layer(s) may be formed as needed. As shown in FIG. 1D, a first conductive layer M1, such as a first metal layer, may be formed on the second dielectric layer 105.

As shown in FIG. 2, third dielectric layers 106 and fourth dielectric layers 107 are formed on the second dielectric layer 105. The third dielectric layers 106 and the fourth dielectric layers 107 may be stacked to alternate with each other, wherein the thicknesses and materials of the layers may not be consistent. The materials of the third dielectric layers 106 and the fourth dielectric layers 107 may be, for example, silicon oxide or silicon nitride. Conductive connection structures are formed in the photonic integrated structure, where the conductive connection structures include conductive layers (M1, M2, M3, M4) and conductive vias (V12, V23, V34). The conductive vias (e.g., through-hole vias) may be used to connect the conductive layers. The number of the conductive layers and the conductive vias may be set as needed. The conductive layers are each surrounded by a third dielectric layer 106 and/or a fourth dielectric layer 107. The number of the conductive connection structures may be set as needed. Some conductive connection structures may be used for electrical connection with the photonic devices, and some may be used for electrical connection with the second conductive opening(s) in the first substrate. Pads 108 and Under Bump Metallurgy (UBM) 109 may further be formed according to electrical connection requirements.

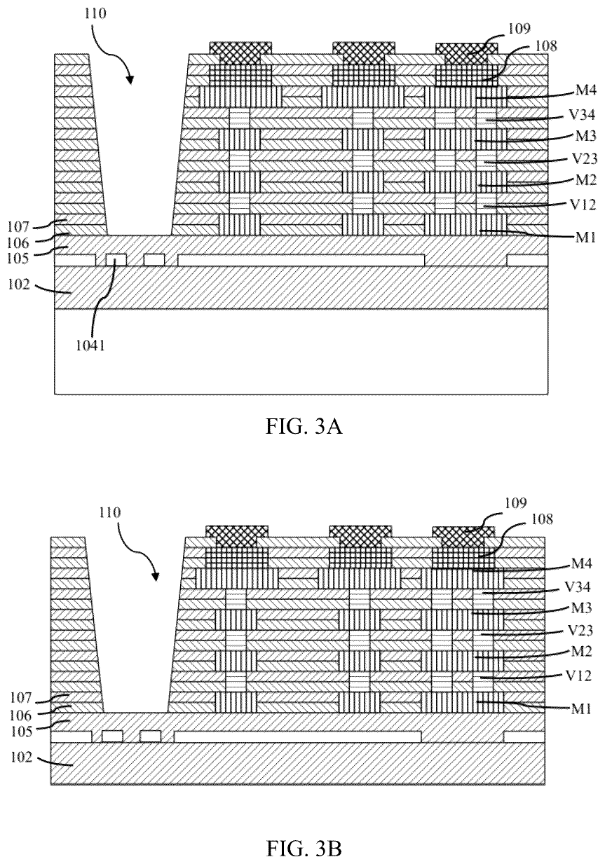

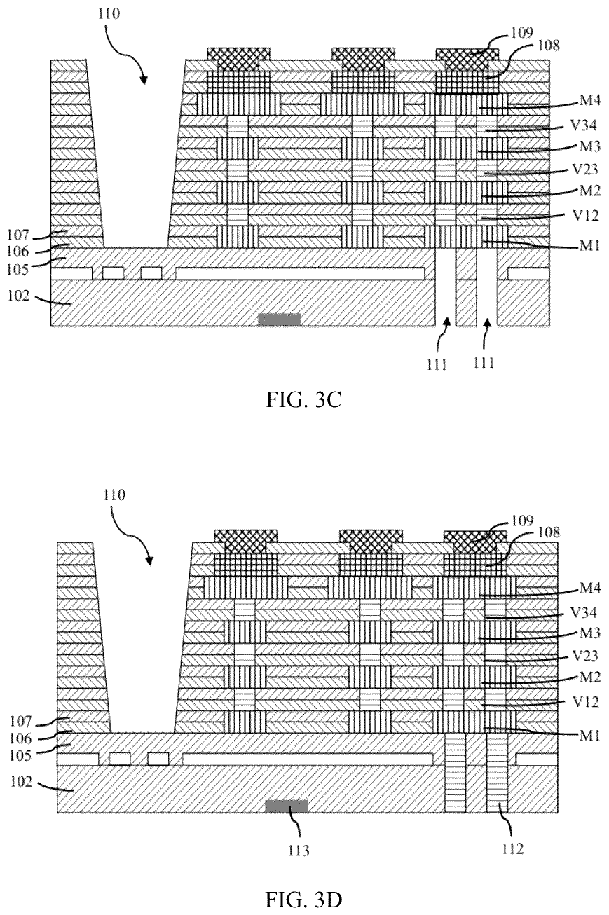

As shown in FIG. 3A, an opening 110 is formed above a grating coupler 1041, where the interior of the opening may be provided with air or other materials to present a suitable refractive index and dielectric constant, thereby forming a light-guiding opening.

As shown in FIG. 3B, the photonic integrated structure has a first side and a second side opposite to the first side. FIG. 3B shows that the photonic integrated structure is thinned from the second side and the back substrate in the SOI substrate is removed, thereby exposing the first dielectric layer 102 from the second side of the photonic integrated structure. Optionally, a portion of the insulation layer in the SOI substrate may be thinned. Therefore, the first dielectric layer 102 is formed from the insulating layer in the SOI substrate. The insulating layer in the SOI substrate may directly serve as the first dielectric layer 102, or the first dielectric layer 102 may be obtained by processing the insulating layer in the SOI substrate, for example, by thinning the insulating layer.

As shown in FIG. 3C, first openings 111 are formed, and the first openings 111 extend in the first dielectric layer 102. The figure shows two first openings 111 corresponding to one M1. For example, when provided in the first dielectric layer 102, the first openings 111 may further extend into other materials. For example, when the first openings 111 are formed, the first openings 111 may extend in the first dielectric layer 102 and the second dielectric layer 105, and the first openings 111 each include a first portion in the first dielectric layer 102 and a second portion in the second dielectric layer 105. In the embodiment as shown in FIG. 3C, the photonic integrated structure may be etched from its second side, thereby forming the first openings 111.

As shown in FIG. 3D, a conductive material is formed in the first openings, thereby forming first conductive openings 112. The first conductive openings 112 are electrically connected with the first conductive layer M1. The first openings may pass through the first dielectric layer 102, and then the corresponding first conductive openings 112 pass through the first dielectric layer 102, forming first conductive through-hole vias. The first through-hole vias pass through the first dielectric layer 102 and the second dielectric layer 105. The first conductive openings 112 are electrically connected to the first conductive layer M1, and pass through the first dielectric layer 102 and the second dielectric layer 105. For example, the forming operations of the first conductive openings 112 in the embodiments of the present disclosure may include a Damascus process.

In addition, one or more functional structures 113 may be formed on the second side of the first dielectric layer 102. Optionally, a redistribution layer (not shown) may further be formed on the second side of the first dielectric layer 102, and the first conductive openings (the conductive material thereof) are electrically connected to the redistribution layer.

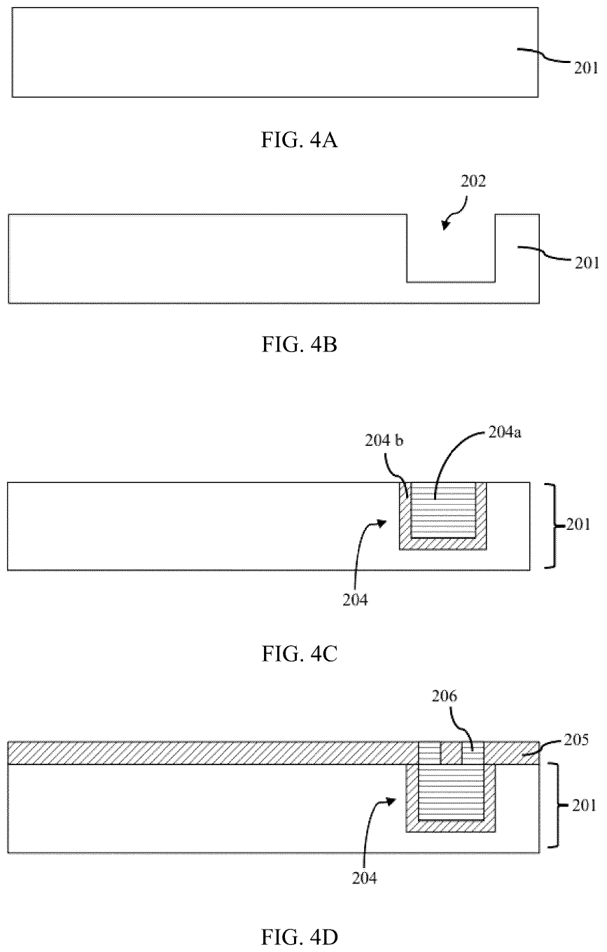

FIGS. 4A-4B show the forming of one or more second openings in the first substrate 201. As shown in FIG. 4A, an original substrate is provided as the first substrate 201, such as a silicon substrate, but is not limited thereto. In FIG. 4B, a second opening 202 is formed in the original substrate by etching, and then a conductive material 204a is formed (as shown in FIG. 4C), thereby forming a second conductive opening 204. Optionally, before disposing the conductive material 204a, an isolation layer 204b may be formed first, and the second conductive opening 204 may include the isolation layer 204b and the conductive material 204a in the second opening, where the isolation layer may include an insulating material. In this process, conventional processes for manufacturing through-silicon vias may be used.

In some embodiments, the first substrate has a first side and a second side, and the second opening is formed from the first side. Then, a conductive material is disposed in the second opening to form a conductive material layer, thereby forming a second conductive opening. For example, the method may include forming an insulating material on a sidewall and a bottom of the second opening to form an insulating isolation layer. In some embodiments, in addition to covering the sidewall and the bottom, the insulating layer may cover the first side of the first substrate. In some embodiments, the second conductive opening is formed by using copper metallization and copper electroplating techniques to fill the second opening.

Optionally, the method may further include, before the operation of disposing the conductive material 204a in the second opening, an operation of forming a barrier layer. The barrier layer may be used as a diffusion barrier to prevent metal in the conductive material layer from diffusing into the substrate, and may further be used as an adhesive layer between the conductive material and the dielectric layer. Exemplary barrier layers may be of materials of, for example, TaN, Ta, Ti, TiN, but are not limited thereto.

A material of the conductive material layer in the second opening may be copper or a copper-based alloy. Exemplary conductive materials may further include materials such as tungsten and aluminum, or other materials with good conductive properties. After the conductive material layer is formed, excess conductive material layer and barrier layer(s) covering a surface of the first substrate may be removed through processes such as grinding and etching. In some embodiments, part or all of the insulating isolation layer covering the substrate surface may be removed by grinding, etching, etc.

Optionally, the first substrate may be a transparent substrate, such as a glass substrate, a quartz substrate, etc., or may be of other common substrate materials in the field.

FIG. 4C shows the forming of the second conductive opening 204 in the first substrate 201, wherein the second conductive opening 204 is formed on the first side of the substrate 201. The method may further include, after the operation of forming the second conductive opening 204, as shown in FIG. 4D, optionally, an operation of forming a dielectric layer (a fifth dielectric layer 205) to cover the surface of the first substrate and the second conductive opening. Third openings are formed in the fifth dielectric layer, and a conductive material is disposed in each third opening to form third conductive openings 206. The third conductive openings 206 may pass through the fifth dielectric layer 205, thereby forming third conductive through-hole vias. The third conductive openings 206 are electrically connected to the second conductive opening 204. The third conductive openings 206 may be a plug, such as a copper plug, and of course may also of other metal materials or conductive materials. The third openings and the second opening may have different-sized opening areas on their aligned sides. For example, one or more of the third openings may be aligned with one second opening. For example, the figure shows two third openings in alignment with the second opening. Unless otherwise specified, the “alignment” between the openings in the present disclosure includes the following situations (taking the alignment of the third opening(s) and the second opening as an example) that the alignment of the third opening(s) and the second opening(s) does not need their centers to be strictly aligned. In some cases, an opening area of the third opening on the aligned side and an opening area of the second opening on the aligned side may only partially overlap, as long as a normal conductive connection is realized. For example, the forming process of the third conductive opening may include a Damascus process.

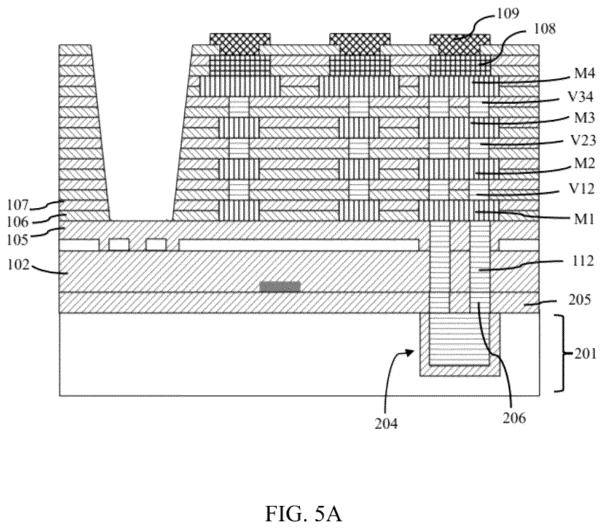

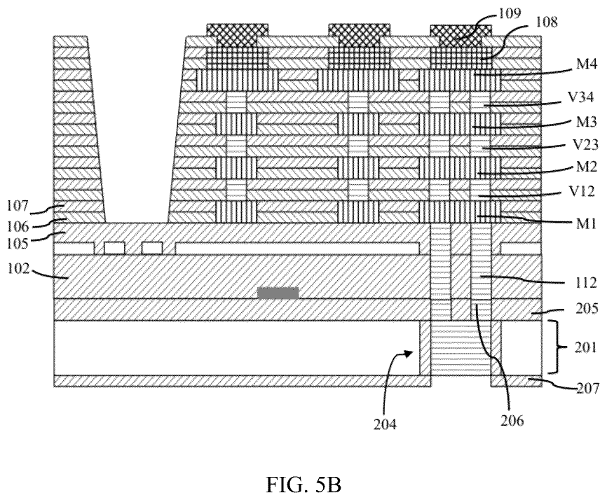

FIG. 5A shows the bonding of the photonic integrated structure to the first substrate. The photonic integrated structure has a first side and a second side opposite to the first side, the first dielectric layer is exposed on the second side of the photonic integrated structure, and the bonding is performed with the second side of the first dielectric layer facing toward the first substrate. For example, during the bonding process, the second side of the first dielectric layer 102 faces the first side of the first substrate 201, such that the first conductive openings 112 of the photonic integrated structure are aligned with the second conductive opening 204 of the first substrate 201, to electrically connect the conductive material in the first openings and the conductive material in the second opening. That is, the first conductive openings 112 and the corresponding second conductive opening 204 are aligned and electrically connected. The first openings and the second opening may have different-sized opening areas on their aligned sides. The alignment of the first opening(s) and the second opening(s) does not need their centers to be strictly aligned. In some cases, an opening area of the first opening(s) on the aligned side and an opening area of the second opening on the aligned side may only partially overlap, as long as a normal conductive connection is realized. For example, one or more second openings are aligned with one first opening. FIG. 5A shows that two first openings are aligned with one second opening, and therefore, two first conductive openings 112 are aligned with one second conductive opening 204. In some embodiments, the photonic integrated structure includes a plurality of first openings, and each second opening may be aligned with one first opening or a group of first openings, wherein the group of first openings include a plurality of first openings. By removing the back substrate of the photonic integrated structure instead of forming any via in the back substrate, an adverse effect of process conditions on the photonic integrated structure when forming vias in the back substrates is reduced.

In some embodiments, external light may enter from the first side of the photonic integrated structure.

In some embodiments, the first opening(s) and the second opening(s) may have different diameters. For example, the first opening(s) may have a smaller diameter than the second opening(s). In some embodiments, the diameter of the second opening(s) is 2 to 10 times the aperture of the first opening(s). The number of the second openings corresponding to one first opening may be adjusted according to the sizes of the openings to obtain suitable electrical connection properties.

In FIG. 5A, there is a fifth dielectric layer 205 between the first substrate and the photonic integrated structure. During the bonding process, the third conductive opening 206 is electrically connected to corresponding first conductive opening(s) 112. The plurality of third openings are respectively aligned with the plurality of corresponding first openings, that is, the third conductive openings 206 are respectively aligned with the corresponding first conductive openings 112. For example, an original oxide layer/insulating layer (a buried oxide layer) of the SOI substrate in the photonic integrated structure may be used as a bonding layer.

The bonding between the photonic integrated structure and the first substrate may adopt an oxide-oxide bonding, such as silicon oxide (SiOx)-SiOx bonding. For example, the first dielectric layer is of a SiOx material, and the fifth dielectric layer is of a SiOx material, where SiOx represents a material system and does not indicate that the first dielectric layer and the fifth dielectric layer have a same oxygen content.

By performing bonding with the dielectric layer (such as the first dielectric layer) in the photonic integrated structure, there is no need to provide an additional bonding structure on the photonic integrated structure, which reduces a process flow.

FIG. 5B shows a schematic diagram of thinning the first substrate 201 from the second side of the first substrate 201 and subsequent processes. In FIG. 5B, the first substrate 201 of FIG. 5A may be thinned on the second side of the first substrate 201 to form a corresponding through substrate via, that is, the second opening is configured to pass through the first substrate 201. Correspondingly, the second conductive opening 204 passes through the first substrate 201 and is formed as a second conductive through-hole via. Optionally, a dielectric layer 207 is formed on the second side of the first substrate 201 (as shown in FIG. 5B). The thinning process may be, for example, grinding, chemical mechanical polishing, etching, etc.

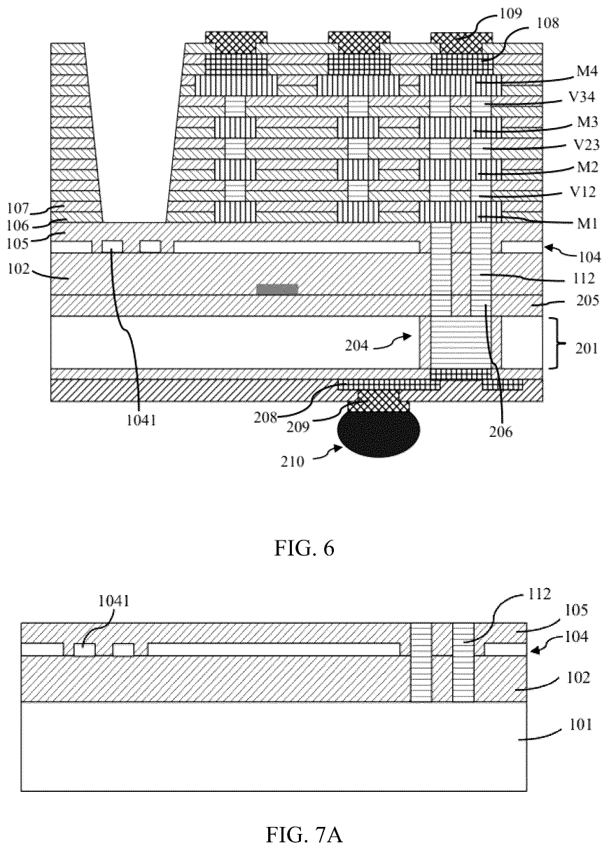

FIG. 6 shows a schematic diagram of a packaging structure after other connection structures are further formed. After FIG. 5B, a redistribution layer (RDL) 208 and a UBM 209 are formed on the second side of the first substrate 201, and the UBM 209 is electrically connected to the redistribution layer 208. The conductive connection member 210 connected to the UBM may be formed according to an electrical connection requirement. The conductive connection member may be a controlled collapse chip connection (C4) bump, a ball grid array (BGA) connector, a solder ball, a metal pillar, a micro-bump, etc. The conductive connection member may include a conductive material such as solder, copper, aluminum, gold, nickel, silver, palladium, tin, etc., or a combination thereof. In some embodiments, the conductive connection member may be formed by first forming a solder layer through common methods such as evaporation, electroplating, printing, etc. In some embodiments, the conductive connection member is a metal pillar, such as a copper pillar, formed by sputtering, electroplating, chemical plating, chemical vapor deposition (CVD), or the like.

The photonic integrated structure and the first substrate may be manufactured separately, so that the photonic integrated structure is not affected when the opening(s) is formed in the first substrate. In addition, the opening(s) in the first dielectric layer in the photonic integrated structure and the opening(s) in the first substrate may be manufactured through different processes, and may have different sizes. For example, the conductive opening(s) in the photonic integrated structure connected to the first substrate may have a smaller diameter than the via(s) in the first substrate, which makes the process easier to implement.

The manufactured packaging structure has a first surface (an upper surface of the packaging structure in FIG. 6) and a second surface opposite to the first surface. The packaging structure includes a conductive path. The conductive path extends between the first surface and the second surface of the packaging structure, and passes through the first conductive opening and the second conductive opening in sequence. For example, the conductive path passes through the first conductive opening, the third conductive opening, and the second conductive opening in sequence.

In some embodiments, a manufacturing order of some materials or layers may be adjusted as needed. For example, the pad 108 and UBM 109 may be formed after the photonic integrated structure is bonded to the first substrate. Optionally, before the photonic integrated structure is bonded to the first substrate, the second opening passing through the first substrate is formed in the first substrate. Optionally, before the photonic integrated structure is bonded to the first substrate, the RDL structure is formed on the second side of the first substrate. Optionally, before the photonic integrated structure is bonded to the first substrate, a redistribution layer may also be formed on the second side of the first dielectric layer of the photonic integrated structure, and the first conductive opening (the conductive material thereof) is electrically connected to the corresponding second conductive opening (the conductive material thereof) in the first substrate through the redistribution layer, and there is no need to align the first conductive opening and the second conductive opening during realizing electrical connection.

Embodiments of the present disclosure provide a packaging structure, which may be manufactured by the packaging method of the present disclosure. An exemplary packaging structure is shown in FIG. 6, including: a photonic integrated structure including one or more first openings and a conductive material disposed in each of the one or more first openings; a first substrate including one or more second openings and a conductive material disposed in each of the one or more second openings. The first opening(s) is each aligned with a corresponding second opening, and the conductive material in the first opening is electrically connected with the conductive material in the second opening.

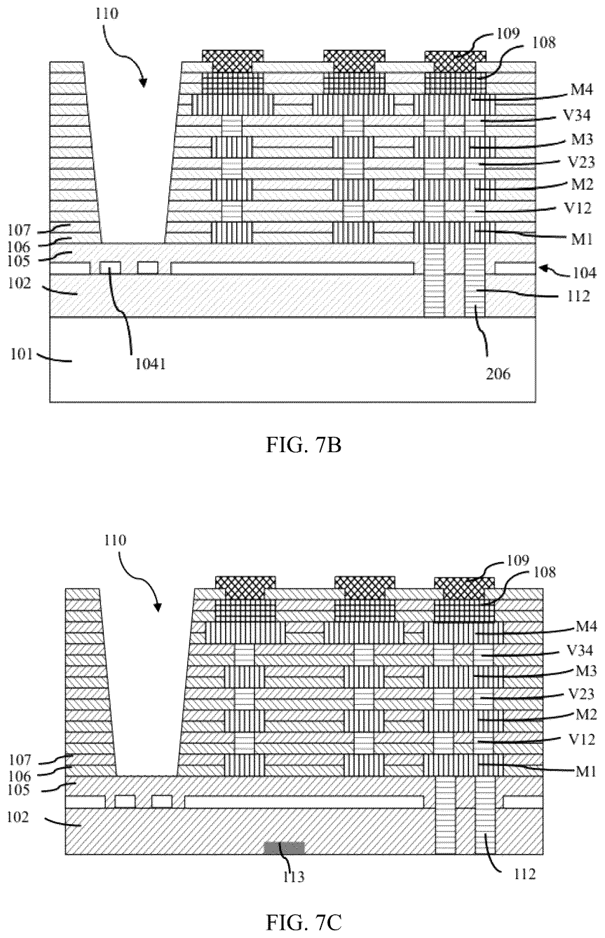

Embodiment 2. In this embodiment, before removing the back substrate in the SOI substrate, the first openings are formed in the first dielectric layer. After the operations of FIG. 1C, the method may include an operation of forming the first openings in the first dielectric layer 102 and disposing the conductive material to form the first conductive openings 112 (as shown in FIG. 7A). In subsequent operations, the back substrate 101 in the SOI substrate is removed. For example, after the second dielectric layer 105 is formed, as shown in FIG. 7A, an etching process is performed to layers from the second dielectric layer 105 to the first dielectric layer 102 to from the first openings passing through the second dielectric layer and the first dielectric layer. The first openings each include a first portion in the first dielectric layer and a second portion in the second dielectric layer. A conductive material is disposed in each of the first openings to form the first conductive vias 112. The first conductive openings 112 pass through the first dielectric layer 102 to form first conductive through-hole vias.

Then, as shown in FIG. 7B, a first conductive layer M1 may be formed on the second dielectric layer 105. Electrical connection structures and other material layers may be further formed as needed. Referring to FIG. 2, the third dielectric layers 106 and the fourth dielectric layers 107 are formed on the second dielectric layer 105. The third dielectric layers 106 and the fourth dielectric layers 107 may be stacked to alternate with each other, wherein thicknesses and materials of the layers may not be consistent. Conductive connection structures are formed in the photonic integrated structure, where the conductive connection structures include conductive layers (M1, M2, M3, M4), and conductive vias (V12, V23, V34). The conductive vias (e.g., through-hole vias) may be used to connect the conductive layers. The conductive layers are each surrounded by a third dielectric layer 106 and/or a fourth dielectric layer 107.

As shown in FIG. 7C, the substrate 101 is then removed, so that the first conductive openings 112 are exposed. In subsequent operations, referring to the corresponding operations in FIGS. 4A to 6, the photonic integrated structure may be bonded to the first substrate.

Embodiments of the present disclosure further provide a photonic integrated circuit chip, which may be manufactured by the packaging method(s) of various embodiments of the present disclosure. The photonic integrated circuit chip includes: a photonic integrated structure including one or more first openings and a conductive material disposed in each of the one or more first openings; a first substrate including one or more second openings and a conductive material disposed in each of the one or more second openings. Each of the first openings is aligned with a corresponding second opening, and the conductive material in the first opening is electrically connected with the conductive material in the corresponding second opening.

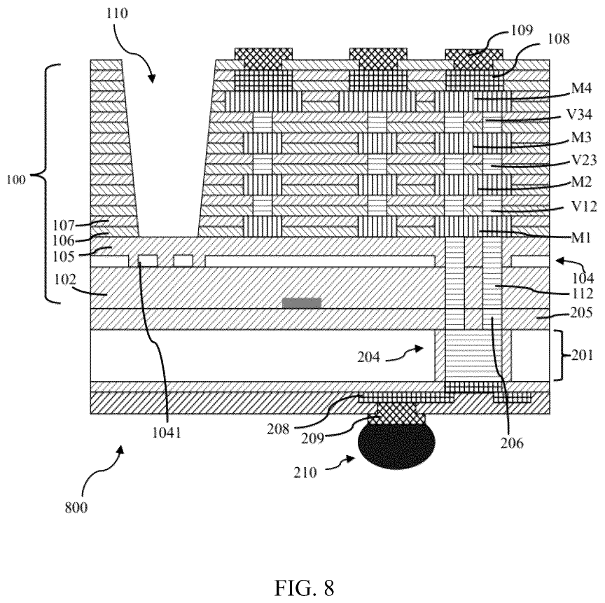

In some embodiments, a photonic integrated circuit chip is as shown in FIG. 8. A photonic integrated circuit chip 800 includes a photonic integrated structure 100, and the photonic integrated structure 100 is disposed above the first substrate 201.

The photonic integrated structure 100 includes the first dielectric layer 102. The first openings extend in the first dielectric layer 102. A conductive material is disposed in each of the first openings to form the first conductive openings 112. The first openings pass through the first dielectric layer 102.

A conductive material is disposed in the second opening to form the second conductive opening 204. The second opening passes through the first substrate 201.

The photonic integrated structure 100 is formed based on an SOI substrate, where the SOI substrate includes a back substrate, an insulating layer, and a top silicon layer. The first dielectric layer 102 may be formed from the insulating layer in the SOI substrate.

The back substrate is removed so that the first dielectric layer 102 is bonded to the first substrate 201.

The photonic integrated structure 100 has a first side and a second side opposite to the first side. The first dielectric layer 102 is exposed on the second side of the photonic integrated structure, and a bonding process is performed with the second side of the photonic integrated structure facing toward the first side of the first substrate 201.

The first dielectric layer 102 has a first side and a second side opposite the first side. The photonic integrated structure includes a photonic device layer 104. The photonic device layer 104 includes various types of photonic devices, such as a waveguide, a grating coupler, an optical modulator, a directional coupler, a multi-mode interferometer (MMI), a photodetector, and an optical beam splitter, etc. The photonic devices are provided on the first dielectric layer 102, that is, the photonic devices are located on the first side of the first dielectric layer 102, and the second side of the first dielectric layer 102 is bonded to the first substrate 201.

The photonic integrated structure further includes a second dielectric layer 105, and the first openings pass through the first dielectric layer 102 and the second dielectric layer 105.

The photonic integrated circuit chip 800 has a first surface (an upper surface of the photonic integrated circuit chip in FIG. 8) and a second surface opposite to the first surface. The photonic integrated circuit includes a conductive path passing through the photonic integrated circuit chip. The conductive path extends between the first surface and the second surface of the photonic integrated circuit chip. In a direction along which the conductive path extends from the first surface to the second surface, the conductive path passes through the first conductive openings 112 and the second conductive opening 204 in sequence. In some embodiments, in the direction along which the conductive path extends from the first surface to the second surface, the conductive path passes through the first conductive openings 112, the third conductive openings 206, and the second conductive opening 204 in sequence.

The photonic integrated circuit chip 800 includes a fifth dielectric layer 205 located between the first dielectric layer 102 and the first substrate 201. The fifth dielectric layer 205 has third openings passing through the fifth dielectric layer 205. The third openings are aligned with the second opening. A conductive material is formed in each of the third openings, so that the conductive material in the third openings is electrically connected to the conductive material in the second opening. In this way, the fifth dielectric layer 205 includes the third conductive openings 206.

In some embodiments, the photonic integrated circuit chip may include a plurality of second openings, and each second opening corresponds to a plurality of first openings.

Those skilled in the art should understand that what is disclosed above is only the implementation manners of the present disclosure, and cannot be used to limit the scope of the patent protection claimed by the present disclosure. Equivalent changes made according to the implementation manners of the present disclosure still fall within the scope of the claims of the present disclosure.

1. A manufacturing method of a packaging structure, comprising:
providing a photonic integrated structure comprising:
one or more first openings, and
a conductive material disposed in each of the one or more first openings;
providing a first substrate comprising:
one or more second openings, and
a conductive material disposed in each of the one or more second openings; and
bonding the photonic integrated structure and the first substrate such that each of the first openings is aligned with a corresponding one of the second openings and the conductive material in the first opening is electrically connected with the conductive material in the corresponding second opening.

2. The manufacturing method of the packaging structure of claim 1, wherein the photonic integrated structure comprises a first dielectric layer, and the one or more first openings pass through the first dielectric layer.

3. The manufacturing method of the packaging structure of claim 2, wherein the one or more second openings pass through the first substrate.

4. The manufacturing method of the packaging structure of claim 2, wherein:
the first substrate has a first side and a second side opposite to the first side, and
the manufacturing method further comprises: thinning the first substrate from the second side of the first substrate, so that the one or more second openings pass through the first substrate.

5. The manufacturing method of the packaging structure of claim 3, wherein the providing of the photonic integrated structure comprises:
forming the photonic integrated structure based on a Silicon-On-Insulator (SOI) substrate, wherein the SOI substrate includes a back substrate, an insulating layer, and a top silicon layer, and the first dielectric layer is formed from the insulating layer in the SOI substrate;
removing the back substrate; and
forming the one or more first openings in the first dielectric layer.

6. The manufacturing method of the packaging structure of claim 5, wherein the forming of the one or more first openings in the first dielectric layer comprises: forming the one or more first openings in the first dielectric layer after the back substrate is removed.

7. The manufacturing method of the packaging structure of claim 5, wherein the forming of the one or more first openings in the first dielectric layer comprises: forming the one or more first openings in the first dielectric layer before the back substrate is removed.

8. The manufacturing method of the packaging structure of claim 4, wherein the photonic integrated structure has a first side and a second side opposite to the first side, the first dielectric layer is located on the second side of the photonic integrated structure, and the bonding is performed with the second side of the photonic integrated structure facing toward the first substrate.

9. The manufacturing method of the packaging structure of claim 8, comprising:
forming an additional dielectric layer on the first side of the first substrate;
forming one or more third openings, wherein the one or more third openings pass through the additional dielectric layer, and the one or more third openings are each aligned with a corresponding one of the one or more second openings; and
forming a conductive material in each of the one or more third openings, wherein when performing the bonding of the photonic integrated structure and the first substrate, the additional dielectric layer is located between the photonic integrated structure and the first substrate, and the conductive material in each of the one or more third openings is electrically connected to the conductive material in the corresponding one of the one or more second openings.

10. The manufacturing method of the packaging structure of claim 8, wherein the first dielectric layer has a first side and a second side opposite to the first side, the photonic integrated structure comprises one or more photonic devices disposed on the first side of the first dielectric layer, and the second side of the first dielectric layer is bonded to the first substrate.

11. The manufacturing method of the packaging structure of claim 10, wherein the one or more photonic devices comprise at least one of a waveguide, a grating coupler, an optical modulator, a directional coupler, a multi-mode interferometer, a photodetector, and an optical beam splitter.

12. The manufacturing method of the packaging structure of claim 11, wherein a second dielectric layer is formed on the first side of the first dielectric layer, the second dielectric layer covers the one or more photonic devices, and the one or more first openings pass through the second dielectric layer.

13. The manufacturing method of the packaging structure of claim 8, wherein a plurality of the first openings are aligned with a corresponding one of the one or more second openings.

14. A packaging structure, comprising:
a photonic integrated structure comprising:
one or more first openings, and
a conductive material disposed in each of the one or more first openings;
a first substrate comprising:
one or more second openings, and
a conductive material disposed in each of the one or more second openings,
wherein each of the first openings is aligned with a corresponding one of the second openings, and the conductive material in the first opening is electrically connected with the conductive material in the corresponding second opening.

15. The packaging structure of claim 14, wherein the photonic integrated structure comprises a first dielectric layer, and the one or more first openings pass through the first dielectric layer.

16. The packaging structure of claim 15, wherein the photonic integrated structure has a first side and a second side opposite to the first side, the first dielectric layer is located on the second side of the photonic integrated structure, and the second side of the photonic integrated structure faces toward the first substrate.

17. The packaging structure of claim 16, wherein the one or more second openings pass through the first substrate.

18. The packaging structure of claim 17, comprising an additional dielectric layer located between the photonic integrated structure and the first substrate,
the additional dielectric layer comprises one or more third openings and a conductive material disposed in each of the one or more third openings,
the one or more third openings pass through the additional dielectric layer, and
each of the one or more third openings is aligned with a corresponding one of the second openings, so that the conductive material in the third opening is electrically connected to the conductive material in the corresponding second opening.

19. The packaging structure of claim 17, wherein the first dielectric layer has a first side and a second side opposite to the first side, the photonic integrated structure comprises one or more photonic devices disposed on the first side of the first dielectric layer, and the second side of the first dielectric layer is bonded to the first substrate.

20. A photonic integrated circuit chip, comprising:
a photonic integrated structure comprising:
one or more first openings, and
a conductive material disposed in each of the one or more first openings;
a first substrate comprising:
one or more second openings, and
a conductive material disposed in each of the one or more second openings,
wherein each of the first openings is aligned with a corresponding one of the second openings, and the conductive material in the first opening is electrically connected with the conductive material in the corresponding second opening.

21. The photonic integrated circuit chip of claim 20, wherein the photonic integrated structure comprises a first dielectric layer, and the one or more first openings extend in the first dielectric layer, wherein the one or more first openings pass through the first dielectric layer.

22. The photonic integrated circuit chip of claim 21, wherein the photonic integrated structure has a first side and a second side opposite to the first side, the first dielectric layer is located on the second side of the photonic integrated structure, and the second side of the photonic integrated structure faces toward the first substrate.

23. The photonic integrated circuit chip of claim 22, wherein the one or more second openings pass through the first substrate.

24. The photonic integrated circuit chip of claim 23, wherein the first dielectric layer is formed from an insulating layer in a Silicon-On-Insulator (SOI) substrate, and a back substrate in the SOI substrate is removed.

25. The photonic integrated circuit chip of claim 24, comprising an additional dielectric layer located between the photonic integrated structure and the first substrate,
the additional dielectric layer comprises one or more third openings and a conductive material disposed in each of the one or more third openings,
the one or more third openings pass through the additional dielectric layer, and
each of the one or more third openings is aligned with a corresponding one of the second openings, so that the conductive material in the third opening is electrically connected to the conductive material in the corresponding second opening.

26. The photonic integrated circuit chip of claim 23, wherein the first dielectric layer has a first side and a second side opposite to the first side, the photonic integrated structure comprises one or more photonic devices disposed on the first side of the first dielectric layer, and the second side of the first dielectric layer is bonded to the first substrate.

27. The photonic integrated circuit chip of claim 26, wherein the one or more photonic devices comprise at least one of a waveguide, a grating coupler, an optical modulator, a directional coupler, a multi-mode interferometer, a photodetector, and an optical beam splitter.

28. The photonic integrated circuit chip of claim 23, wherein a second dielectric layer is formed on the first side of the first dielectric layer, the second dielectric layer covers the one or more photonic devices, and the one or more first openings pass through the second dielectric layer.

29. The photonic integrated circuit chip of claim 23, wherein a plurality of the first openings are aligned with a corresponding one of the one or more second openings.

30. The photonic integrated circuit chip of claim 23, wherein the photonic integrated circuit chip has a first surface and a second surface opposite to the first surface, and the photonic integrated circuit chip comprises one or more conductive paths extending between the first surface and the second surface of the photonic integrated circuit chip,
wherein the one or more first openings provided with conductive material are one or more first conductive openings, and the one or more second openings provided with conductive material are one or more second conductive openings, and
the one or more conductive paths each pass through one or more of the one or more first conductive openings and one or more of the one or more second conductive openings in sequence along a direction along which the conductive path extends from the first surface to the second surface.
